(19) United States
(12) Patent Application Publication
(10) Pub. No.: US 2026/0105279 A1
(43) Pub. Date: Apr. 16, 2026

(54) ADAPTABLE NEURAL NETWORK WITH SIDE-CHANNEL STRUCTURE FOR INFERENCE KNOWLEDGE CONTROL FOR KNOWLEDGE UPDATING AND REFLECTION IN GENERATIVE FOUNDATION MODEL, AND INFERENCE AND TRAINING METHOD BASED THEREON

(71) Applicant: ELECTRONICS AND TELECOMMUNICATIONS RESEARCH INSTITUTE, Daejeon (KR)

(72) Inventor: Jong Hun Shin, Daejeon (KR)

(21) Appl. No.: 19/206,721

(22) Filed: May 13, 2025

(30) Foreign Application Priority Data
Oct. 15, 2024 (KR) 10-2024-0140665

(51) Int. Cl. G06N 3/042; G06N 3/0475; G06N 3/084

(52) U.S. Cl. CPC G06N 3/042; G06N 3/0475; G06N 3/084

(57) ABSTRACT

Disclosed are an adaptable neural network and an inference and training method based thereon. The adaptable neural network includes a neural network including a residual block implemented as a neural network layer, the residual block including multiple layers in which an input representation of a current layer is added to an output representation and delivered to a neural network layer of a next layer, and a knowledge control unit completely separated from the neural network. The residual block includes a primitive model unit indicating a set of weight parameters composed of certain neural network layers, an updated knowledge adjustment unit indicating an adapter neural network coexisting with weight parameters of the primitive model unit, and a representation combination unit including a separate side-channel for receiving a signal indicating combination/non-combination, and configured to combine results of forward computation of the primitive model unit and the updated knowledge adjustment unit.

### CROSS-REFERENCE TO RELATED APPLICATION

The present application claims priority to and the benefit of Korean Patent Application No. 10-2024-0140665, filed on Oct. 15, 2024, in the Korean Intellectual Property Office, the entire disclosure of which is incorporated herein by reference.

### BACKGROUND

### 1. Field of the Invention

The present disclosure relates to an adaptable neural network with a side-channel structure for inference knowledge control for knowledge updating and reflection in a generative foundation model, and an inference and training method based thereon.

### 2. Description of Related Art

A generative foundation model is a scheme for distorting or removing portions of primitive data (raw data), such as web text or an image, and thereafter predicting the distorted or removed portions. The generative foundation model contains foundational knowledge through a pre-training stage where the model learns semantic representations of tokens constituting input. After pre-training, the generative foundation model undergoes an alignment process using techniques such as supervised fine-tuning and human-preference learning based on reinforcement learning in order to generate output matching desired intentions, thus enabling a generative language model to perform its own roles. In other words, the source of knowledge for solving problems may be obtained during a pre-training stage, and the generative foundation model may be prompted to function appropriately through an alignment process to achieve a means for solving the problems.

The pre-training stage in which the source of knowledge is obtained needs to mobilize tens to thousands of times more computing resources than those in the alignment process. Such a disadvantage makes it practically difficult to update the knowledge of the foundation model. As a result, conventional generative foundation models exhibit a temporal cut-off in knowledge that the models have learned, either explicitly or implicitly.

Real-world environments to which such a foundation model is applied require the reflection of constantly changing information. Since the foundation model cannot respond to the latest information, it returns outdated knowledge learned during the pre-training stage, leading to user inconvenience due to the inability to receive accurate current (up-to-date) information.

The problem arises in that it is not easy to reflect the up-to-date information in the foundation model. As described above, although large-scale computing resources are required, there is a need to update weight parameters constituting the foundation model in a process in which the foundation model learns the up-to-date information. During such an update process, a problem arises in that a phenomenon in which existing knowledge is forgotten may occur, and control related to which knowledge is forgotten cannot be performed.

### SUMMARY OF THE INVENTION

Embodiments of the present disclosure are directed to providing a neural network construction method and a training method, which can adjust neural network weight parameters that have learned updated knowledge so that the neural network weight parameters can selectively intervene in a generation process so as to solve technical problems occurring when updating is attempted using conventional technology.

An adaptable neural network according to an embodiment of the present disclosure may include a neural network including a residual block implemented as a neural network layer, the residual block including multiple layers in which an input representation of a current layer is added to an output representation and an added representation is delivered to a neural network layer of a next layer, and a separate knowledge control unit completely separated from the neural network. The residual block may include a primitive model unit corresponding to a part of a foundation model having a frozen weight, and indicating a set of weight parameters composed of certain neural network layers in the residual block, an updated knowledge adjustment unit indicating an adapter neural network coexisting with the weight parameters of the primitive model unit in the residual block, and a representation combination unit including a separate side-channel for receiving a signal indicating combination or non-combination from the knowledge control unit, and configured to combine a result of forward computation of the primitive model unit with a result of forward computation of the updated knowledge adjustment unit in response to a signal from the knowledge control unit.

In an embodiment, the updated knowledge adjustment unit may include one or more neural network weight layers having inputs and outputs of dimensions respectively identical to an input dimension of the primitive model unit at a point at which branching occurs and an output dimension of the primitive model unit at a point at which branching points are merged.

In an embodiment, the updated knowledge adjustment unit may be trained with updated knowledge that the primitive model unit has not learned.

In an embodiment, training of the updated knowledge adjustment unit may be performed through a process including freezing all weights of the primitive model unit and enabling the updated knowledge adjustment unit to be trainable, calculating a loss function between a value predicted after forward computation between training sessions and a value to be actually output, and propagating a gradient in reverse through backward computation using a calculated loss value.

In an embodiment, the loss function may be identical to a loss function used for pre-training of the primitive model unit.

In an embodiment, the representation combination unit may learn determination of a strength of combination of the result of forward computation of the updated knowledge adjustment unit with the result of forward computation of the primitive model unit using cross-entropy loss in a state in which weights of the primitive model unit and weights of the updated knowledge adjustment unit are frozen not to be reflected in training.

In an embodiment, the knowledge control unit may deliver the signal indicating combination or non-combination for knowledge control is to be performed, and a reflection strength of combination to the representation combination unit through the side-channel.

In an embodiment, the representation combination unit may be configured to, when the signal indicating combination or non-combination is false, output an output vector of the primitive model unit without change, and when the signal indicating combination or non-combination is true, output a vector obtained by adding the output vector of the primitive model unit to a vector, obtained by multiplying the reflection strength by an output vector of the updated knowledge adjustment unit.

In an embodiment, the knowledge control unit may be trained by constructing mock inputs using both data used for updating training and remaining data that is not used, and labeling an input generated from updated training data as true while labeling an input constructed from the remaining data as false.

An inference and training method in which updated knowledge of a generative foundation model is reflected according to an embodiment of the present disclosure includes inputting a user input to a knowledge control unit and to a residual block, for each of multiple layers of the residual block implemented as a neural network layer in which an input representation of a current layer is added to an output representation and an added representation is delivered to a neural network layer of a next layer, obtaining a partial output by iteratively performing a process including 1) obtaining a first representation vector for a next output through forward computation of a neural network layer constituting a primitive foundation model, 2) obtaining a second representation vector through forward computation of a weight parameter space updated using updated knowledge, 3) selectively combining the first representation vector with the second representation vector based on an output value of the knowledge control unit, and 4) utilizing a combined representation as a forward computation value of a next layer, and obtaining an output by aggregating the partial output and the user input and by delivering an aggregated result to the knowledge control unit, and obtaining a final output by iteratively performing outputting of a next partial output of the generative foundation model by the forward computation based on the obtained output.

In an embodiment, the weight parameter space updated using updated knowledge may include one or more neural network weight layers having inputs and outputs of dimensions respectively identical to an input dimension of the primitive foundation model at a point at which branching occurs and an output dimension of the primitive foundation model at a point at which branching points are merged.

In an embodiment, the weight parameter space updated using updated knowledge may be trained with updated knowledge that the primitive foundation model has not learned.

In an embodiment, the inference and training method may further include training the weight parameter space updated using the updated knowledge through a process including, freezing all weights of the primitive foundation model and enabling the weight parameter space to be trainable, calculating a loss function between a value predicted after forward computation between training sessions and a value to be actually output, and propagating a gradient in reverse through backward computation using a calculated loss value.

In an embodiment, as the loss function, a loss function identical to a loss function used for pre-training of the primitive foundation model may be used.

In an embodiment, the inference and training method may further include learning determination of a strength of combination of the first representation vector with the second representation vector using cross-entropy loss in a state in which weights of the primitive foundation model and weights of the weight parameter space are frozen not to be reflected in training.

In an embodiment, an output value of the knowledge control unit delivered in the combining may include a signal indicating combination or non-combination of the first representation vector with the second representation vector and a reflection strength of the second representation vector, and the output value of the knowledge control unit may be delivered through a side-channel.

In an embodiment, the combining may include when the signal indicating combination or non-combination is false, outputting an output vector of the primitive model unit without change, and when the signal indicating combination or non-combination is true, outputting a vector obtained by adding the output vector of the primitive model unit to a vector, obtained by multiplying the reflection strength by an output vector of the updated knowledge adjustment unit.

In an embodiment, the inference and training method may further include training the knowledge control unit by constructing mock inputs using both data used for updating training and remaining data that is not used and by labeling an input generated from updated training data as true while labeling an input constructed from the remaining data as false.

According to the present disclosure, there is no need to newly train a generative foundation model that has been trained and deployed from scratch in order to additionally train the generative foundation model with updated knowledge.

Further, according to the present disclosure, whether knowledge additionally learned using a side-channel from an external system intervenes may be precisely determined for respective layer positions as needed, without the loss of previously learned characteristics of a generative foundation model due to additional training, thus preventing other inference knowledge from being distorted or from being excessively applied due to training data for updating.

Since neural network weight parameters that have learned updated knowledge are selectively applied in this way, malfunctions that may occur during a process of generating normal phrases, not requiring updated knowledge, may be reduced even when the updated knowledge is required.

The effects of the present disclosure are not limited to those mentioned above, and other effects not explicitly stated will be clearly understood by those skilled in the art from the following description.

### BRIEF DESCRIPTION OF THE DRAWINGS

The following drawings attached to this specification illustrate preferred embodiments of the present disclosure, and help to further understand the technical spirit of the present disclosure along with the aforementioned contents of the disclosure. Accordingly, the present disclosure should not be construed as being limited to only contents described in such drawings:

FIG. 1 is a block diagram for explaining an operating principle according to an embodiment of the present disclosure.

FIG. 2 is a block diagram illustrating an example of the primitive neural network structure of a generative foundation model.

FIG. 3 is a flowchart illustrating a procedure of training an adaptable neural network according to an embodiment of the present disclosure.

FIG. 4 is a flowchart illustrating a training procedure in a first step according to an embodiment of the present disclosure.

FIG. 5 is a flowchart illustrating a procedure of allowing a representation combination unit to learn the determination of combination strength according to an embodiment of the present disclosure.

### DETAILED DESCRIPTION OF THE INVENTION

The above object and other objects, advantages and features of the present disclosure, and methods for achieving the same will be cleared with reference to embodiments described later in detail together with the accompanying drawings.

However, the present disclosure is not limited to the embodiments disclosed below, and may be implemented in various other forms. The following embodiments are merely provided to enable those skilled in the art to easily understand the objects, configuration, and effects of the present disclosure. The scope of the present disclosure should be defined by the description of the accompanying claims.

Meanwhile, the terminology used in the present specification is intended solely for the purpose of describing embodiments and is not intended to limit the scope of the present disclosure. In the present specification, the singular forms also include the plural forms unless the context clearly indicates otherwise. The terms “comprises” and/or “comprising” used in the specification are merely intended to indicate that components, steps, operations, and/or elements described below are present, and do not exclude the presence or addition of one or more other components, steps, operations, and/or elements.

A generative foundation model obtains the source of knowledge for solving problems from a pre-training stage and performs a correct operation through an alignment process so as to achieve a means that solves problems. Meanwhile, the knowledge of the foundation model is guided to be retrieved in conformity with the intention of a user and a format using a relatively small amount of data through the alignment process. During this process, a primary objective is to retrieve knowledge contained in the foundation model with minimal degradation. In order to achieve this objective, a “parameter-efficient fine-tuning” technique that achieves an alignment process by adjusting a much smaller number of parameters than the number of parameters constituting the neural network is occasionally used. Representative examples of the parameter-efficient fine-tuning technique include techniques referred to as adapter neural networks (adapter networks), such as LoRA [Hu et al., (2021). “LoRA: Low-Rank Adaptation of Large Language Models,” arXiv:2106.09685], and Infused Adapter by Additive Attention (IA³) [Liu et al., (2022). “Few-shot Parameter Fine-Tuning is Better and Cheaper than In-Context Learning,” arXiv:2205.05638].

These techniques achieve the objective using a method of freezing all or some of weight parameters constituting the original foundation model to prevent the values of the weight parameters from being changed in a fine-tuning stage, and of modifying the output values of layers constituting each neural network using added weight parameters. When such a technique is further applied, added weight parameters may be independently configured multiple times and aligned according to respectively different intentions. Further, if necessary, added weight parameters, which are differently configured, may be selectively included, and thus various tasks may be performed using changes in a smaller number of parameters.

Freezing the weight parameters of a neural network body may be interpreted as preserving the previously learned knowledge. In the present disclosure, the weight parameters of the neural network body are frozen, and added weight parameters are attached or added to the neural network body to prevent knowledge established during a pre-training stage from being forgotten and to learn up-to-date knowledge through the added weight parameters. In other words, it can be seen that the size of the weight parameter space is treated as a kind of memory space and that a larger space is required to accommodate more knowledge.

Considering a process of updating knowledge contained in the foundation model and a process of utilizing the updated knowledge for inference, data in which the ‘up-to-date’ knowledge to be refreshed is represented in a specific format and contained is first required for knowledge updating. By means of this data, the value of each output to be calculated may vary by updating the weight parameters additionally attached to the neural network. Meanwhile, in order to reflect the updated knowledge in a utilization stage such as inference, output calculated through the frozen neural network weights of the existing body foundation model needs to be combined with output calculated through additionally introduced weight parameters. In this combination process, the stage of configuring the output of a generative foundation model should be iteratively performed due to the features of the generative foundation model. As a result, the introduced parameters participate in calculation at each time for each layer into which the parameters are introduced, a number of times identical to those of the body foundation model.

For example, in a method that utilizes autoregressive decoding, the next word is sequentially predicted as follows. When user input is given with the condition “Please introduce yourself,” the generative foundation model returns individual vocabulary tokens as follows. The generated tokens are reused as the input of the neural network and utilized to predict the next token.

Unique numbers of the predicted token ==><81><90><14530><5810><9891><1856><910><357><1139><250> . . . .

After the unique numbers are replaced with vocabulary tokens ==><I><am><a><neural network><-based><language><generation><model><.> . . . .

However, during a process of generating output in this way, since updated weight parameters to obtain up-to-date knowledge always influence the output generation process, a problem arises in that they are also applied to parts on which the updated knowledge should not have an effect, thus inevitably causing the output to differ from the previous output even though the knowledge of the foundation model body has not been forgotten.

On the other hand, assuming that weight parameters correspond to a kind of memory space as described above, the amount of knowledge to be updated gradually increases over time, and a space for added weight parameters is inevitably added several times in an independent form to extend the memory space. The problem is that, although each of these weight parameter spaces added in this way contains its own updated knowledge, it is unclear which updated knowledge should intervene and when the intervention should be executed during an inference stage, thus making it difficult to decide when learned independent weights should be involved in computation in an inference time slot.

In order to solve this problem, a method of first analyzing input and deterministically utilizing an independent weight parameter space may be considered. However, when this method is utilized, a problem arises in that other updated knowledge cannot participate in an output generation process in the middle of generation of current output. As another approach, there is a method of determining an independent weight parameter space, which is prepared in advance in a computation process, in an inference stage and of combining the independent weight parameter space with a computation result using a method such as Mixture-of-LoRAs (MOA). However, since this method also requires training of router neural network weights for determining which space is to be used, there are limitations in that a large independent space needs to be allocated in advance (when the space is increased after being allocated, the router neural network needs to be initialized again and newly trained), and in that domain information needs to be inserted into input in a stage of configuring the input and then information for determining which space is to be actually utilized should be delivered in advance. Furthermore, this method cannot solve the problem in which added neural network parameters are always excessively reflected in an inference process, as in the case of the above-addressed problem.

The present disclosure adjusts neural network weight parameters that have learned updated knowledge so that the neural network weight parameters can selectively intervene in a generation process.

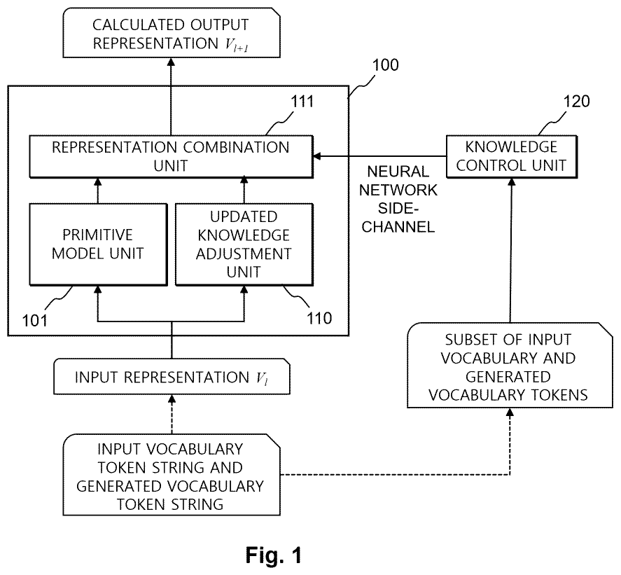

FIG. 1 is a block diagram illustrating the configuration of an adaptable neural network according to an embodiment of the present disclosure. A residual block 100 of FIG. 1 is composed of one or more neural network layers constituting a primitive foundation model. The residual block 100 is defined as a subset of a neural network in which an input representation Vₗ of layer l is added to an output representation Vₗ₊₁ and an added representation is delivered to a neural network layer of the next layer l+1.

A primitive model unit 101 is a part of a weight-frozen foundation model into which an added weight parameter is to be combined, and is a set of weight parameters, composed of arbitrary neural network layers within the residual block 100.

An updated knowledge adjustment unit 110 may be an adapter neural network (adapter network) that coexists with the weight parameters of the primitive model unit 101 within the designated residual block 100. The updated knowledge adjustment unit 110 is composed of one or more neural network weight layers that have input/output of the same dimensions as the input dimension of a foundation model at the point at which branching occurs (i.e., a branching point) and as the output dimension of the foundation model at the point at which branching points are merged (i.e., a merging point), respectively. As the updated knowledge adjustment unit 110, not only an adapter neural network structure described in the present specification but also an adapter neural network structure used in conventional technology (e.g., LoRA or the like) may be adopted without change as long as they meet such requirements.

A representation combination unit 111 is a module which combines the result of forward computation of primitive model weights with the result of forward computation of adapter neural network weights, and includes an input side-channel independent of the input/output of the neural network. A separate side-channel input is provided to receive information for determining whether to combine the result of forward computation of the primitive model unit 101 for input with the result of forward computation of the updated knowledge adjustment unit 110 from a knowledge control unit 120 and to make determination based on the information.

The knowledge control unit 120 is a separate inference knowledge control module completely separate from the neural network structure, and transmits a signal indicating combination or non-combination to the side-channel of the representation combination unit 111. The knowledge control unit 120 may be implemented using a machine learning-based model, a rule-based method including a heuristic method by a human being, or a search-based method for searching for a portion of updated knowledge to determine true or false. The knowledge control unit 120 delivers the signal indicating combination or non-combination for knowledge control and parameters to be used to determine a combination ratio through the side-channel of the representation combination unit 111.

In order to implement the knowledge control unit 120, there is essentially required a training or correction process of distinguishing a portion in which existing knowledge needs to be retained from a portion in which new knowledge required for updating is to be reflected. This will be described in detail later.

Next, the operation of the present disclosure will be described by taking an example in which a generative language model is used as a generative foundation model. In the following description, a language model for generating text is used to help the understanding of the configuration and training of the neural network and inference, but the generation of audio signals (e.g., waveform) or images is also performed in such a way as to use a sequence generation method that is utilized in the generative language model or to use an iterative denoising concept, thus sequentially generating a final image. In this way, the concept of inference in the generative foundation model is to generate the next output by combining input with output through an iterative process, and stop the generation of output when a specific condition (e.g., when a signal indicating the end of a sentence is received, or the designated limit of the maximum generation is reached) is satisfied. Therefore, in an embodiment of the present disclosure, the characteristics of text modalities are partially disclosed for understanding of the present disclosure, but they limit neither the structure of the present disclosure nor application to other modalities.

### 1) Neural Network Structure and Inference Method of Generative Foundation Model

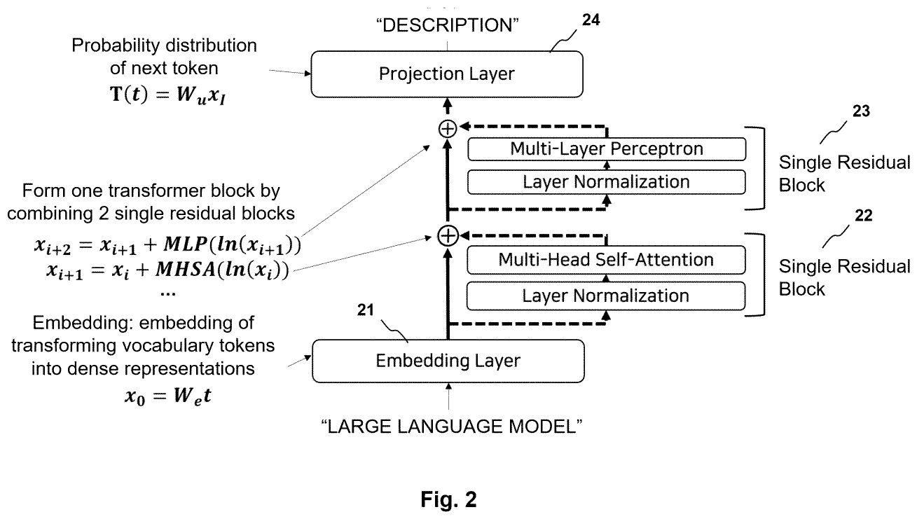

First, for understanding of a generative foundation model, description will be made with reference to FIG. 2. FIG. 2 is a diagram illustrating in brief the primitive neural network structure of a foundation model, and depicts a Generative Pre-trained Transformer (GPT) neural network such as Large Language Model Meta (LLaMA), which is one of widely used foundation models.

The generative foundation model splits input into string units called tokens and converts the string units into vectors of several hundreds to thousands of dimensions through an embedding layer 21 so that the dependent representations (e.g., in the case of text, the “large language model” of FIG. 2) of modalities to be handled (referring to text, audio (voice), or image) can be processed by a neural network. The vectors are referred to as “dense representations.”

Each converted vector is applied, as input, to each of residual blocks 22 and 23, and values constituting the representation thereof are changed through forward computation (i.e., a calculation process of generating output values by sequentially applying a series of designated operation rules such as multiplying or adding the input by or to stored weight parameters). The reason for representing this process by residual blocks is that, when a value, obtained by transforming the representation that is input to each residual block through the forward computation, is calculated, this value is added to a dense representation at an input time point and an added result is delivered to the next layer, rather than being used as the input of the next residual block (or next layer) without change. That is, the delivered value may be expressed by xᵢ₊₁=xᵢ+ResidualBlock(xᵢ). A large foundation model may be formed by stacking at least tens of residual blocks in the foundation model.

Through a method corresponding to an inverse process of the embedding process (i.e., unembedding) in a projection layer 24, the finally generated representation is transformed into a probability distribution over the output token vocabulary of the foundation model, so that probability distributions for respective vocabulary tokens are output, and sampled values are replaced with vocabulary token values depending on the probability distributions and are output as fragments of vocabulary/text representations that can be viewed by persons.

The above-described initial structure may be referred to as a neural network structure definition of a primitive model. By utilizing the neural network definition of this primitive model, the neural network structure of the primitive foundation model is instantiated. The weights of the primitive model unit 101 at this time may be initialized to random values sampled from a normal distribution initialized through designated average and variance characteristics. Thereafter, an adapter neural network (updated knowledge adjustment unit) 110 and a representation combination unit 111 are defined and initialized at specific positions within the section of the residual block 100 of primitive model definition. As illustrated in FIG. 1, the section in which the adapter neural network is located is present at the same layer level as the residual block.

In the present disclosure, one of two types of adapters for modifying the output of the residual block 100 may be selected to define the adapter neural network 110. Assuming that the input of forward computation for weights of the primitive model unit 101 of the l-th residual block 100 of the primitive model is defined as hₗ₋₁, the output of the forward computation is defined as hₗ, a weight set of the primitive model unit 101 used for the forward computation is W_{θ}, and a weight set of an added adapter neural network, that is, the updated knowledge adjustment unit 110 is W_{φ}, individual adapters are defined as follows. For simplicity and clarity of definition, activation/nonlinearity and bias, which may be selectively used between the components of the adapter layer, are omitted from notation.

$$serialized adapter neural network : {h}_{l} = {h}_{l - 1} {W}_{θ} + ( {h}_{l - 1} {W}_{θ} ) W ϕ \qquad ( a )$$

$$parallelized adapter neural network : {h}_{l} = {h}_{l - 1} {W}_{θ} + {h}_{l - 1} W ϕ \qquad ( b )$$

Neural network definition corresponding to (a) may be composed of a plurality of feed-forward layers and an activation function that connect the feed-forward layers. Examples of the serialized adapter neural network may include adapters, AdaMix, ReFT that is an interventional adapter neural network, and the like.

Neural network definition corresponding to (b) may include a parallel adapter having a structure in which a plurality of linear transformation layers and an activation function are combined, LoRA that is a reparameterization-based adapter neural network, a modified method thereof (e.g., DoRA), and the like.

Because the updated knowledge adjustment unit 110 and the representation combination unit 111 modify the results of forward computation of primitive models in all sections in residual blocks constituting the primitive model unit 101, the size of the input of the updated knowledge adjustment unit 110 generally needs to match the input dimension defined by the primitive model unit 101. However, in the case of (a) corresponding to the serialized adapter, since the input size may vary with the specific position in the residual block 100, it needs to match the size of the output dimension of a previous layer. Additionally, the dimension of the output representation produced by the representation combination unit 111 should be the same as the output dimension of the primitive model unit 101.

In an embodiment of the present disclosure, two linear transformation layers are added using LoRA corresponding to (b). When the primitive model is used in LLaMA-2 7B scale, the corresponding model uses a dimension representation of 4096 dimensions. Therefore, when the rank that is one of hyper-parameter values of LoRA is set to 8, if the rank is applied to the linear transformation layer of the primitive model, added layer A has a matrix size with a form of [8, 4096], and the other layer B has a matrix size with a form of [4096, 8]. This can be applied to all or some of 64 residual blocks (i.e., 32 transformer blocks=32 MLP residual blocks+32 MHSA residual blocks). In the present embodiment, it is assumed that the application is made to all blocks.

Because the added adapter layers are located at the same layer level as the weight of the primitive model, the representation combination unit 111 should exist on a layer just above the added adapter layers. The representation combination unit 111 may receive the output of the knowledge control unit 120 outside the neural network model through the side-channel of the neural network, and may determine whether to reflect (=combine) the output result of the updated knowledge adjustment unit 110 in (with) the result of forward computation of the primitive model.

In an inference stage, the number of parameters used to determine whether to reflect learned weights in the adapter may be two.

1) Signal indicating whether to combine the results of forward computation of the representation combination unit 111 and the updated knowledge adjustment unit 110 (true/false)

2) Strength (ratio) at which the combination of the representation combination unit 111 and the updated knowledge adjustment unit 110 is reflected during combination

Assuming that a representation vector calculated through the forward computation of weights of the primitive model unit 101 in the l-th residual block is h_{θ}, a representation vector calculated through the forward computation of the updated knowledge adjustment unit 110 in the same residual block is h_{φ}, and the reflection strength of combination is a single scalar variable [symbol] , a final output h′ may be calculated as follows:

$${h}^{′} = \{ \begin{matrix}{h}_{θ} & when FALSE \\ {h}_{θ} + z ⊕ {h}_{ϕ} & when TRUE\end{matrix}$$

When the representation combination unit 111 receives an external signal from the knowledge control unit 120 and determines that the result of forward computation of the updated knowledge adjustment unit 110 is not to be reflected, the result h_{θ} of forward computation of the primitive model unit 101 is returned without change, as in the case of “when FALSE” in the above equation. On the other hand, when it is determined that the result of forward computation of the updated knowledge adjustment unit 110 is to be reflected, a single scalar variable z corresponding to the reflection strength is multiplied by the output value returned through forward computation of the updated knowledge adjustment unit 110, the multiplied result is combined with the result of forward computation of the primitive model unit 101 using a defined method, and then the combined result is returned. In some embodiments, it may be possible to produce the case where the result of forward computation is not reflected using a method of setting the reflection strength [symbol] to the inverse of h_{θ} in the implementation of the representation combination unit 111 and delivering the reflection strength to be 0.

The updated knowledge adjustment unit 110 and the representation combination unit 111 may be located in all residual blocks 100 constituting the primitive model unit 101, and may be combined with only some subsets of the residual blocks in a definition stage. At the initialization time of the representation combination unit 111, the locations of residual blocks in the entire neural network are remembered, and thus weight reflection degrees in an array type may be received to selectively reflect weights located in a specific residual block.

When the definition of a neural network model including the primitive model unit 101, the updated knowledge adjustment unit 110, and the representation combination unit 111 is instantiated, initialization is completed by fetching weight parameter values stored in the primitive foundation model. Since the foundation model does not have weight values, the updated knowledge adjustment unit 110 that uses an explicitly defined weight parameter space needs to be initialized to random values. Also, the representation combination unit 111 may secure the reflection strength z as the parameter of the learnable parameter space, after which the knowledge control unit 120 may receive only true/false of combination and then determine whether to perform combination. In this way, when the representation combination unit 111 intends to optimize the reflection strength of the updated knowledge adjustment unit 110 in the pre-training of the model or in the stage of performing fine-tuning, the weight parameter space of the representation combination unit 111 at this time may be filled with random values sampled using a normal distribution initialized with designated average and variance characteristics. Alternatively, after all of weight spaces are initialized to a single scalar value (e.g., 0) so that the output of the updated knowledge adjustment unit 110 is always excluded or combined, the value may be treated as a learnable parameter and updated in a training stage.

The knowledge control unit 120 receives an initial input vocabulary token sequence (Wᵢ={W₁, . . . , Wₖ}), corresponding to the input value of a primitive model, and (typically windowed) subsets of a token sequence (Wₒ={Wₖ₊₁, . . . , Wₖ₊₁}) that has been generated based on the input value up to the token immediately before a (t+1)-th token to be subsequently generated and that has been re-fed into the input, and generates either a single scalar variable in a real value format for the representation combination unit 111, or a parameter array (vector) having the same size as the number of added updated knowledge adjustment units 110.

When the output is defined as Cₒᵤₜ, a subset of the input token sequence is defined as Sᵢ⊆Wᵢ, and a subset of the output of the current model based on the subset is defined as Sₒ⊆Wₒ, the knowledge control unit 120 may define the output as the following function ƒ:

$${C}_{out} = f ( {S}_{i ,} {S}_{o} )$$

The knowledge control unit 120 may be implemented as a machine learning model, such as a linear regression model or a classification model combined with a vocabulary embedding layer. When a structure in which reflection strength is determined is used in the representation combination unit 111, the machine learning model may be replaced with a deterministic heuristic or retrieval-based method incorporating a keyword extraction technique. In this case, only a value indicating whether an updated knowledge representation that is closest to or matches the user input is partially present is generated and delivered to the side-channel of the representation combination unit 111.

### 2) Method of Training Modified Neural Network Using Updated Data

When data containing knowledge for updating, which is not learned, is present in a primitive model unit, the data needs to be reflected in the modified neural network so as to achieve updating of a foundation model.

In conventional technology, updated knowledge is directly applied to the modified neural network, so that continual pre-training is performed by assigning objectives for performing next token prediction or masked token denoising where certain tokens are corrupted and then restored, or so that fine-tuning for weights is performed to suit a specific task, after which resulting models are directly utilized to meet the corresponding purpose. However, when the modified neural network is simply trained using the same procedures as in the conventional technology through the above-described method, it becomes impossible to distinguish the case where tokens requiring updated knowledge are generated from the remaining cases. Therefore, there is a need to perform control so that the cases can be distinguished from each other.

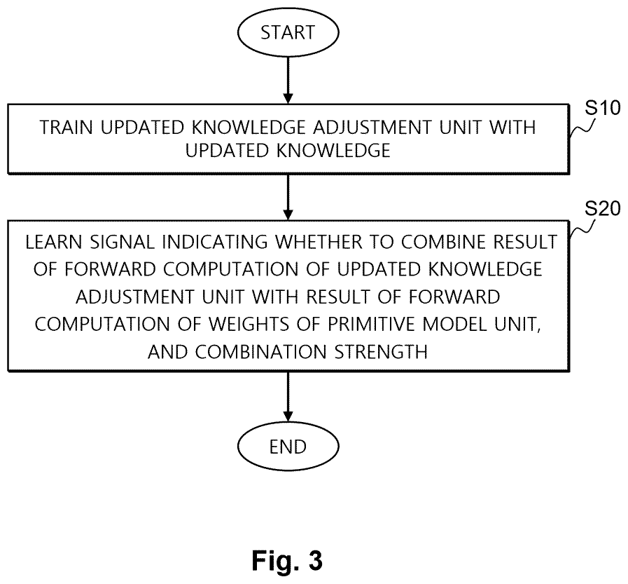

In the present disclosure, a method of training a neural network with updated data using a two-step training method is provided. FIG. 3 illustrates a training procedure according to an embodiment of the present disclosure. The method of training the neural network with updated data according to the embodiment of the present disclosure may include a first step (step S10) of training a modified foundation model with updated data, and a second step (step S20) of learning, based on data, a signal indicating whether to combine the result of forward computation of an added weight space, which is learned in the first step, that is, an updated knowledge adjustment unit 110, with the result of forward computation of weights of a primitive model unit 101, and with the combination strength of the results. Hereinafter, operations in respective steps will be described in detail.

### <First Step>

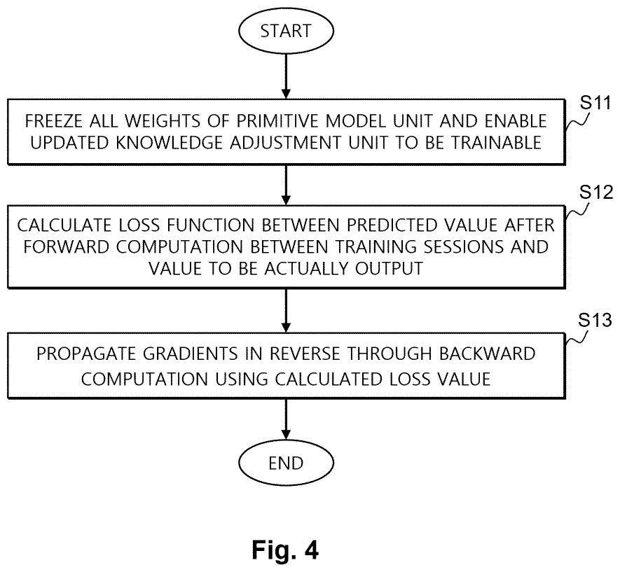

FIG. 4 illustrates a training procedure in the first step according to an embodiment of the present disclosure. First, weights of the primitive model unit 101 may be frozen, and the added weight parameter space, that is, the updated knowledge adjustment unit 110, may be trainable in step S11. A representation combination unit 111 may be pre-tuned to utilize the result obtained through forward computation of the added weight parameter space without separate tuning.

Next, a loss function between a value predicted after forward computation between training sessions and a value to be actually output is calculated in step S12. As the loss function for updating neural network parameters, the same loss function as the loss function utilized for pre-training of a generative foundation model may be used without change.

The updated knowledge adjustment unit 110 is caused to learn data for updating by propagating gradients in reverse through backward computation using a calculated loss value in step S13.

An example of an available loss function will be described. In the case of a foundation model that generates language tokens, assuming that an initial input language token sequence x=(x₁, . . . , xₙ) and a prediction target language token sequence y=(y₁, . . . , yₘ) to be predicted are present and that forward computation for combination of a target to learn weight parameters based on the data with the updated knowledge adjustment unit 110 and the primitive model is defined as P_{φ} (⋅), a cross-entropy loss function is defined below, and the added weight parameter φ is updated to minimize the loss function by performing training.

$$loss = {min}_{ϕ} - {\sum }_{i = 1}^{m} log {p}_{ϕ} ( {𝓎}_{i} \vert 𝓍𝓎 < i )$$

### <Second Step>

The second step is the step of learning, based on the data, the signal indicating whether to combine the result of forward computation of the added weight space trained in the first step, that is, the updated knowledge adjustment unit 110, with the result of forward computation of weights of the primitive model unit 101, and the combination strength thereof. When the added parameter space is inserted into the representation combination unit 111 and only true/false for combination is delivered by the knowledge control unit 120 through a side-channel, the combination strength thereof is determined based on training by the representation combination unit 111.

Even in the case where a separate parameter space is not present in the representation combination unit 111 and the knowledge control unit 120 also delivers a signal indicating combination strength, information about whether intervention of the added weight space 110 trained in second step is accurate or inaccurate may be fed back to the knowledge control unit 120, thus verifying whether the signal issued by the knowledge control unit 120 is accurate, or correcting the corresponding signal. For the second step, two pieces of data are required:
1) updated data used in the first step
2) data similar to that used in existing pre-training step, other than the updated data.

By modeling the knowledge control unit 120 using a machine learning method through two pieces of data belonging to different categories in this way, true/false may be determined.

Since the knowledge control unit 120 uses a portion of context, the used data needs to be split into units suitable for various token positions smaller than the size of primitive data. When a fixed size is handled as the size of the input of the knowledge control unit 120, portions of input and output may be left depending on the fixed size. A maximum of 150 tokens are received as input context and only the most recent 50 tokens are used from the generation history, and then a binary classification model for returning true/false determination is created by receiving the 200 tokens as input. In accordance with a designated format in this way, mock inputs may be constructed using both data that was used in the update training and the remaining data that was not. Also, the inputs generated from the updated training data are labeled as TRUE, and inputs constructed from the remaining data are labeled as FALSE, whereby the model may be trained. When an output label is defined as id (combine)/od (discard), ground truth is defined as [symbol] ᵢ, and the predicted output of the current binary classification model is defined as [symbol] , the binary classification model having the following loss function may be trained:

$$BCEloss ( {𝓎}_{i} , \hat{{𝓎}_{i}} ) = - \frac{1}{N} {\sum }_{i = 1}^{N} [ {𝓎}_{i} \cdot log ( \hat{{𝓎}_{i}} ) + ( 1 - {𝓎}_{i} ) \cdot log ( 1 - \hat{{𝓎}_{i}} )$$

The combination strength of the representation combination unit 111 is determined to be a scalar variable having a single real number value in each combination unit. However, the combination strength needs to be determined differently depending on the current position of the token. Therefore, a vector having the same dimension as the current position of the token sequence processed by the neural network needs to be a weight parameter space and to be present for each layer. That is, when the trainable parameter space of the representation combination unit has a total of/layers and the current position is at an i-th token, the trainable parameter space

$$V = \{ {υ}_{l}^{i} \vert ( l , i ) \}$$

should be present.

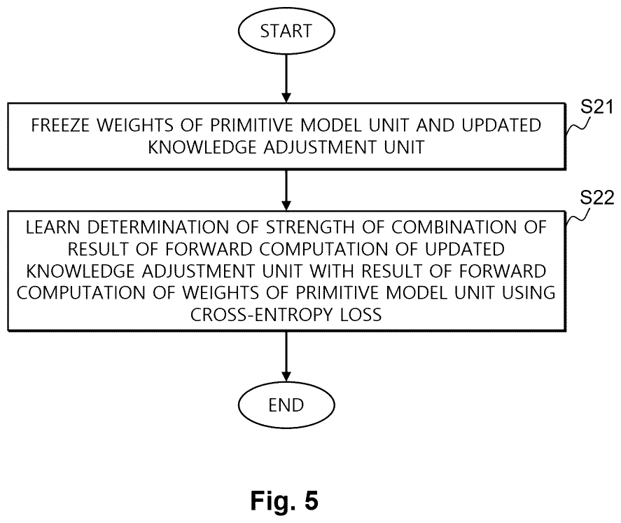

In an embodiment, a procedure in which the representation combination unit 111 learns the determination of strength is illustrated in FIG. 5. First, in the state in which the weights of the remaining spaces, other than the parameter space of the representation combination unit, that is, the weights of the primitive model unit 101, and the weights of the updated knowledge adjustment unit 110 are frozen not to be reflected in training in step S21, the trainable parameter space V may be trained using typical cross-entropy loss used in the first step, whereby the parameters of the representation combination unit are adjusted to determine strength in step S22.

When the knowledge control unit 120 and the representation combination unit 111 are trained to determine whether intervention at a token level is to be performed while undergoing the first step and the second step in this way, the representation combination unit adjusts reflection strength by reflecting parameters, learned based on the updated knowledge, depending on the current positions of tokens and selectively reflects the updated knowledge in response to the output signal of the control unit (=signal indicating combination or non-combination) while performing inference. As a result, the probability distribution of output tokens may be adjusted through the inverse of an embedding process (i.e., unembedding).

The method according to an embodiment of the present disclosure may be implemented in the form of program instructions executable through various types of computer means, and may be recorded on a computer-readable medium.

The computer-readable medium may include program instructions, data files, data structures, or the like, either alone or in combination. The program instructions recorded on the computer-readable medium may be specially designed and configured for implementing the present disclosure, or may be known and available to those skilled in the field of computer software. A computer-readable recording medium may include hardware devices configured to store and execute program instructions. For example, the computer-readable recording medium may include magnetic media such as a hard disk, a floppy disk, and magnetic tape, optical media such as CD-ROMs and DVDs, magneto-optical media such as a floptical disk, ROM, RAM, and flash memory. The program instructions may include not only machine code, such as code produced by a compiler, but also high-level language code that can be executed by a computer using an interpreter or the like.

While the embodiments of the present disclosure have been described in detail above, it should be understood that the scope of the present disclosure is not limited thereto. Various modifications and alterations made by those skilled in the art, based on the basic concept of the disclosure defined in the accompanying claims, may also fall within the scope of the present disclosure.

What is claimed is:

1. An adaptable neural network, comprising:
a neural network including a residual block implemented as a neural network layer, the residual block including multiple layers in which an input representation of a current layer is added to an output representation and an added representation is delivered to a neural network layer of a next layer; and
a separate knowledge control unit completely separated from the neural network,
wherein the residual block comprises:
a primitive model unit corresponding to a part of a foundation model having a frozen weight, and indicating a set of weight parameters composed of certain neural network layers in the residual block;
an updated knowledge adjustment unit indicating an adapter neural network coexisting with the weight parameters of the primitive model unit in the residual block; and
a representation combination unit including a separate side-channel for receiving a signal indicating combination or non-combination from the knowledge control unit, and configured to combine a result of forward computation of the primitive model unit with a result of forward computation of the updated knowledge adjustment unit in response to a signal from the knowledge control unit.

2. The adaptable neural network as claimed in claim 1, wherein the updated knowledge adjustment unit comprises:
one or more neural network weight layers having inputs and outputs of dimensions respectively identical to an input dimension of the primitive model unit at a point at which branching occurs and an output dimension of the primitive model unit at a point at which branching points are merged.

3. The adaptable neural network as claimed in claim 2, wherein the updated knowledge adjustment unit is trained with updated knowledge that the primitive model unit has not learned.

4. The adaptable neural network as claimed in claim 3, wherein training of the updated knowledge adjustment unit is performed through a process comprising:
freezing all weights of the primitive model unit and enabling the updated knowledge adjustment unit to be trainable,
calculating a loss function between a value predicted after forward computation between training sessions and a value to be actually output, and
propagating a gradient in reverse through backward computation using a calculated loss value.

5. The adaptable neural network as claimed in claim 4, wherein the loss function is identical to a loss function used for pre-training of the primitive model unit.

6. The adaptable neural network as claimed in claim 3, wherein the representation combination unit learns determination of a strength of combination of the result of forward computation of the updated knowledge adjustment unit with the result of forward computation of the primitive model unit using cross-entropy loss in a state in which weights of the primitive model unit and weights of the updated knowledge adjustment unit are frozen not to be reflected in training.

7. The adaptable neural network as claimed in claim 1, wherein the knowledge control unit delivers the signal indicating combination or non-combination for knowledge control is to be performed, and a reflection strength of combination to the representation combination unit through the side-channel.

8. The adaptable neural network as claimed in claim 7, wherein the representation combination unit is configured to:
when the signal indicating combination or non-combination is false, output an output vector of the primitive model unit without change, and
when the signal indicating combination or non-combination is true, output a vector obtained by adding the output vector of the primitive model unit to a vector, obtained by multiplying the reflection strength by an output vector of the updated knowledge adjustment unit.

9. The adaptable neural network as claimed in claim 1, wherein the knowledge control unit is trained by constructing mock inputs using both data used for updating training and remaining data that is not used, and labeling an input generated from updated training data as true while labeling an input constructed from the remaining data as false.

10. An inference and training method in which updated knowledge of a generative foundation model is reflected, the inference and training method comprising:
inputting a user input to a knowledge control unit and to a residual block;
for each of multiple layers of the residual block implemented as a neural network layer in which an input representation of a current layer is added to an output representation and an added representation is delivered to a neural network layer of a next layer, obtaining a partial output by iteratively performing a process comprising:
1) obtaining a first representation vector for a next output through forward computation of a neural network layer constituting a primitive foundation model,
2) obtaining a second representation vector through forward computation of a weight parameter space updated using updated knowledge,
3) selectively combining the first representation vector with the second representation vector based on an output value of the knowledge control unit, and
4) utilizing a combined representation as a forward computation value of a next layer; and
obtaining an output by aggregating the partial output and the user input and by delivering an aggregated result to the knowledge control unit, and obtaining a final output by iteratively performing outputting of a next partial output of the generative foundation model by the forward computation based on the obtained output.

11. The inference and training method as claimed in claim 10, wherein the weight parameter space updated using updated knowledge comprises one or more neural network weight layers having inputs and outputs of dimensions respectively identical to an input dimension of the primitive foundation model at a point at which branching occurs and an output dimension of the primitive foundation model at a point at which branching points are merged.

12. The inference and training method as claimed in claim 11, wherein the weight parameter space updated using updated knowledge is trained with updated knowledge that the primitive foundation model has not learned.

13. The inference and training method as claimed in claim 12, further comprising:
training the weight parameter space updated using the updated knowledge through a process comprising,
freezing all weights of the primitive foundation model and enabling the weight parameter space to be trainable,
calculating a loss function between a value predicted after forward computation between training sessions and a value to be actually output, and
propagating a gradient in reverse through backward computation using a calculated loss value.

14. The inference and training method as claimed in claim 13, wherein the loss function is identical to a loss function used for pre-training of the primitive foundation model.

15. The inference and training method as claimed in claim 12, further comprising:
learning determination of a strength of combination of the first representation vector with the second representation vector using cross-entropy loss in a state in which weights of the primitive foundation model and weights of the weight parameter space are frozen not to be reflected in training.

16. The inference and training method as claimed in claim 10, wherein:
an output value of the knowledge control unit delivered in the combining includes a signal indicating combination or non-combination of the first representation vector with the second representation vector and a reflection strength of the second representation vector, and
the output value of the knowledge control unit is delivered through a side-channel.

17. The inference and training method as claimed in claim 16, wherein the combining comprises:
when the signal indicating combination or non-combination is false, outputting an output vector of the primitive model unit without change; and
when the signal indicating combination or non-combination is true, outputting a vector obtained by adding the output vector of the primitive model unit to a vector, obtained by multiplying the reflection strength by an output vector of the updated knowledge adjustment unit.

18. The inference and training method as claimed in claim 10, further comprising:
training the knowledge control unit by constructing mock inputs using both data used for updating training and remaining data that is not used and by labeling an input generated from updated training data as true while labeling an input constructed from the remaining data as false.
